(19) United States
(12) Patent Application Publication
(10) Pub. No.: US 2024/0279089 A1
(43) Pub. Date: Aug. 22, 2024

(54) METHOD FOR CONTROLLING THE GROWTH OF MICROORGANISMS

(71) Applicant: RED BULL GMBH, Fuschl am See (AT)

(72) Inventors: Hans KLEMENS, Fuschl am See (AT); Daniel HERZOG, Fuschl am See (AT)

(21) Appl. No.: 18/569,542

(22) PCT Filed: Jun. 30, 2022
(86) PCT No.: PCT/EP2022/068123

§ 371 Date: Dec. 12, 2023

(30) Foreign Application Priority Data
Jun. 30, 2021 (EP) 21182926.2

(51) Int. Cl. C02F 1/76

(52) U.S. Cl. CPC C02F 1/76; C02F 2209/04; C02F 2303/04

(57) ABSTRACT

The present patent application relates to a process for controlling the growth of microorganisms in at least partially circulating process water of an industrial plant, comprising the step of introducing an aqueous solution containing chlorine dioxide into the process water in order to set a redox potential of 400 to 800 mV in the process water, wherein the aqueous solution containing chlorine dioxide having a pH value of 4 to 7.5 and a ratio of chlorine dioxide to chloride ions of greater than 1, wherein the process water having a temperature of 5 to 50° C.

### TECHNICAL FIELD

The present invention relates to the field of controlling the growth of microorganisms in industrial plants.

### BACKGROUND OF THE INVENTION

The control of microbial contamination is crucial in many industrial processes in order to be able to produce high-quality and durable products and to keep plants on which those processes are performed hygienically clean and operational. Controlling microbial growth is a top priority especially in the food sector, since, in this case, the shelf life of the manufactured product also plays a major role.

The undesirable and uncontrolled growth of microbes, particularly of bacteria and fungi, in industrial plants that are operated at least partially with water (e.g., pasteurization plants, cooking plants) is a well-known problem which is solved in various ways. Chemical as well as mechanical and thermal processes are used in this case, wherein the growth of microbes is actually controlled chemically and/or thermally in most cases.

Depending on the area of application, the use of chemical processes for controlling microorganisms is very common and, in many cases, is accompanied by thermal measures. For example, chlorine oxide is used for improved inactivation of microbial organisms in aqueous solutions (U.S. Pat. No. 7,922,933 B2). Chlorine dioxide is also used as an oxidizing agent in processes for inhibiting biofilms in pipes of heat exchangers (US 2007/081573 A1). The use of aqueous solutions comprising certain compounds is disadvantageous despite good efficiency against microorganisms, as some of the compounds that are employed are usable only to a limited extent in the food sector due to their toxicity. Another disadvantage of many chemical compounds is that they promote corrosion in aqueous solutions. This means that industrial plants which comprise components made of metal, in particular of steel or, respectively, stainless steel, can be exposed to increased corrosion because of the use of certain antimicrobial compounds.

In the food sector, for example, corrosive aqueous solutions have a negative effect not only on the industrial plants in which they are used, but also on metal containers filled with food and contacted with the corrosive solution (e.g., cans or bottles provided with metal caps in pasteurization plants).

It is thus an object of the present invention to provide a process which allows to control the growth of microorganisms in process water, wherein the process water should have a low corrosion rate in comparison to metals.

### SUMMARY OF THE INVENTION

It has surprisingly been shown that the microbial contamination in process water can be controlled or. respectively. reduced particularly well by adding chlorine dioxide in the form of an aqueous solution containing chlorine dioxide. provided that. by adding the chlorine dioxide. the redox potential in the process water is adjusted to a value of 400 to 800 mV. Especially as a result of the combined setting of a defined redox potential (adjusted with an aqueous solution containing chlorine dioxide) and a defined pH value. a particularly high efficacy is shown, both against the undesirable growth of microorganisms in the process water and against the undesirable formation of biofilms on surfaces of the industrial plant in which the process water is located. For this reason. the aqueous solution containing chlorine dioxide, which is used according to the invention. has a pH value of 4 to 7.5. In addition, the process water into which the solution containing chlorine dioxide is introduced has a temperature of 5 to 50° C. A temperature of the process water which is too high causes chlorine dioxide to be expelled from the process water and to endanger the safety of the plant and of the working staff operating the plant. In addition. as temperatures rise. the solubility of chlorine dioxide in water decreases. whereby the concentration of the chlorine dioxide dissolved in the process water is reduced.

Moreover, it has been shown that the pH value and the (molar) ratio of chlorine dioxide to chloride ions in the solution containing chlorine dioxide have a significant influence on the corrosiveness of the solution or. respectively. the process water. A pH value of the solution containing chlorine dioxide of less than 4 leads to higher corrosiveness of the process water, as its pH value is influenced by the addition of the solution containing chlorine dioxide. Furthermore, if the ratio of chlorine dioxide to chloride ions in the aqueous solution containing chlorine dioxide is more than 1. the corrosiveness of the process water is significantly reduced. If the ratio of chlorine dioxide to chloride ions in the aqueous solution containing chlorine dioxide is even more than 1.5. preferably more than 2. more preferably more than 3. more preferably more than 5. more preferably more than 10. more preferably more than 100. the corrosiveness can be reduced further.

Surprisingly. it has been found that it is beneficial that the aqueous solution containing chlorine dioxide. at a concentration of chlorine dioxide adjusted with distilled water of 1000 ppm. exhibits a corrosion rate on steel 1.4301 of less than 0.6 mm/year. preferably less than 0.55 mm/year. more preferably less than 0.5 mm/year. at room temperature. and/or. at a concentration of chlorine dioxide adjusted with distilled water of 50 ppm. exhibits a corrosion rate on steel 1.4301 of less than 0.25 mm/year. preferably less than 0.20 mm/year. at room temperature. As a result. it is possible to drastically reduce corrosion in the industrial plant without impairing the effect on microorganisms.

### DESCRIPTION OF EMBODIMENTS

The process according to the invention can be used for controlling or, respectively. inhibiting the growth of microorganisms such as bacteria and fungi. Because of the oxidative effect of chlorine dioxide. the growth of cells in general (all prokaryotic and eukaryotic cells) and of microorganisms in particular is inhibited. With the process according to the invention. not only is it possible to control planktonic microorganisms. but the process prevents or, respectively. reduces the formation of biofilms on surfaces of industrial plants.

By using an aqueous solution containing chlorine dioxide, which, at a concentration of chlorine dioxide of 1000 ppm. has a corrosion rate on steel 1.4301 of less than 0.6 mm/year at room temperature. the corrosion rate of the process water on the industrial system decreases drastically without impairing the antimicrobial effect. According to the invention. the corrosion rate is determined according to the standard ASTM G31-72. In doing so. an aqueous solution containing chlorine dioxide is produced. which comprises 1000 ppm (1000 mg/l) chlorine dioxide. For producing this test solution containing chlorine dioxide, chlorine dioxide is introduced into distilled water at 25° C. until said test solution exhibits 1000 ppm chlorine dioxide. A plate made of steel 1.4301 is immersed in said test solution at 25° C. and the weight loss of the plate after 120 hours is used for the calculation of the corrosion rate.

The process according to the invention comprises the step of mixing or. respectively. adding an aqueous solution containing chlorine dioxide into process water. “Process water”. as used herein. includes water that is used in an industrial process and serves for the operation of plants (industrial plants) in order to implement the industrial process. The end product manufactured in the course of the industrial process or. respectively. intermediate and preliminary products thereof does/do not come into direct contact with the process water during the industrial process. Process water can therefore be water, which is used. for example. for cleaning (e.g., “Cleaning-in-Place”. CIP) plants and machines. Water used in pasteurization plants. energy storage tanks (e.g., for heating purposes for heat consumers) or cooling towers can also be regarded as process water.

The aqueous solution containing chlorine dioxide is added in an amount that is sufficient for setting the redox potential of the process water to between 400 and 800 mV. The added amount of the aqueous solution containing chlorine dioxide can therefore vary and depends, on the one hand. on the concentration of chlorine dioxide present in the aqueous solution and. on the other hand, on the pH value of the solution.

Particularly preferably. the process according to the invention is used for controlling the microbial contamination of process water in a pasteurization plant. in a bottle washing plant. in a thermal plant for bottles and/or in an autoclave (process water is used as a coolant). In this connection. the use of an aqueous solution containing chlorine dioxide for the treatment of process water from pasteurization plants is particularly advantageous. With regard to such plants. it has been shown that metal plant parts with the process water treated according to the invention do not show any increased corrosion despite oxidizing agents. unlike untreated process water. In addition. it has surprisingly been shown that metal packages. especially aluminium packages (e.g., aluminium cans). do not show any signs of corrosion due to the addition of aqueous solutions containing chlorine dioxide in order to achieve the claimed redox potential range in the process water. This means that metal packages can be brought particularly well into contact with process water (e.g., in the course of a pasteurization process) which is treated with the process according to the invention.

It is therefore particularly preferred to use the process water treated according to the invention for the cleaning. pasteurization and/or sterilization of containers. preferably aluminium containers such as aluminium cans. In the process according to the invention. an aqueous solution containing chlorine dioxide is fed into the process water until the redox potential in the process water ranges from 400 to 800 mV. It has been shown especially in this potential range that the growth of cells. particularly of microorganisms. can be controlled or. respectively. suppressed particularly well without promoting the corrosion of metals such as steel within an industrial plant.

The aqueous solution containing chlorine dioxide, which is used according to the invention, can be produced with a wide variety of processes. Particularly preferred are processes by means of which aqueous solutions containing chlorine dioxide can be produced which have a molar ratio of chlorine dioxide to chloride ions of greater than 1. Processes preferred according to the invention are furthermore able to produce aqueous solutions containing chlorine dioxide which have a pH value of 4 to 7.5. For example, chlorine dioxide can be produced in an aqueous solution by oxidizing chlorite with peroxodisulphate or chlorine gas as an oxidizing agent. Alternative processes include the production of chlorine dioxide by disproportionation of sodium chlorite in an acidic solution. Another alternative process is the conversion of potassium chlorate by means of concentrated sulfuric acid. although the risk of explosion in this method is particularly high. Since the formation of chlorate is lowest in the production of chlorine dioxide by oxidation of chlorite (e.g., sodium chlorite) with peroxodisulphate (e.g., sodium peroxodisulphate). this process is particularly preferred. as. in this way. it becomes possible to use the solution in which chlorine dioxide is produced directly in the process according to the invention. The direct use of solutions containing chlorine dioxide which can be prepared with sodium chlorite and sulfuric acid or another (strong) acid is less preferred as they exhibit corrosive anions and a low pH value that promotes corrosion. In such a case, chlorine dioxide would have to be removed from the reaction solutions by means of complex distillation processes (with vacuum. for example) and would have to be introduced into aqueous solutions with a pH value of 4 to 7.5 and a small amount of corrosion-promoting anions, ideally in water free from chloride ions or in water with a low concentration of chloride ions (less than 150 ppm, preferably less than 100 ppm). Thus, according to the invention, particularly preferred is the use of processes which enable the production of an aqueous solution containing chlorine dioxide with a ratio of chlorine dioxide to chloride ions of greater than 1.

According to a preferred embodiment of the present invention, the redox potential of the process water is set to 400 to 700 mV, preferably to 400 to 650 mV, more preferably to 400 to 600 mV.

According to a further preferred embodiment of the present invention, the concentration of chlorine dioxide in the process water ranges from 0.02 to 0.9 ppm, preferably from 0.05 to 0.8 ppm, more preferably from 0.05 to 0.5 ppm, more preferably from 0.1 to 0.5 ppm.

The aqueous solution containing chlorine dioxide is added to the process water in order to preferably set a concentration of 0.02 to 0.9 ppm chlorine dioxide in the process water. This concentration range is particularly advantageous as it is surprisingly sufficient for setting the redox potential in the process water in a range of 200 to 800 mV. Contrary to expert opinion, even such a low concentration of chlorine dioxide is sufficient for controlling or, respectively, inhibiting the growth of cells, in particular of microorganisms. In addition, it has been found that such a concentration of chlorine dioxide has essentially no negative impact on the corrosion of metal plant parts (e.g., made of steel, stainless steel). At higher concentrations of chlorine dioxide, problems associated with corrosion might indeed arise within a plant.

Furthermore, the decreased use of chlorine dioxide also has an economic advantage, as the costs for the oxidizing agent that is used can thereby be reduced without noting any limitation in the efficacy of the chlorine dioxide.

According to a particularly preferred embodiment of the present invention, the concentration of chlorine dioxide in the aqueous solution containing chlorine dioxide ranges from 1,000 to 40,000 ppm, preferably from 2,000 to 30,000 ppm, more preferably from 5,000 to 20,000 ppm.

According to a preferred embodiment of the present invention, the aqueous solution containing chlorine dioxide has a pH value of 4.5 to 7.5, preferably of 5 to 7.

In order to stabilize chlorine dioxide in an aqueous solution, it is advantageous to set or, respectively, stabilize the pH value of said solution in a neutral to acidic range. A high pH value can namely lead to the decomposition of the chlorine dioxide, in the course of which explosive chlorate can form, for example.

The process according to the invention has the advantage that, despite the excellent control of the growth of cells, in particular of microorganisms, the process water has essentially no or, respectively, very low corrosive properties (e.g., towards metals such as steel and stainless steel), since the concentration of chlorine dioxide in the process water is low. In order to further reduce the corrosive properties of the process water mixed with chlorine dioxide, it is advantageous if the aqueous solution containing chlorine dioxide comprises only small or no amounts of corrosion-promoting anions (such as, e.g., chloride). It is therefore particularly advantageous that the aqueous solution containing chlorine dioxide has a molar ratio of chlorine dioxide to chloride ions of greater than 1 or, respectively, as few corrosion-promoting anions as possible.

In order to reduce the concentration of corrosion-promoting anions, in particular of chloride ions and sulfate ions, in the aqueous solution containing chlorine dioxide, processes for the production of chlorine dioxide or, respectively, aqueous solutions containing chlorine dioxide can be applied wherein particularly few of those anions are introduced. For example, processes for the production of aqueous solutions containing chlorine dioxide can be applied wherein a low concentration of corrosion-promoting anions arises. Therefore, chlorine dioxide is particularly preferably produced in an aqueous solution by oxidizing chlorite with peroxodisulphate.

According to a further preferred embodiment of the present invention, the aqueous solution containing chlorine dioxide shows a corrosion rate on steel 1.4301 of less than 0.6 mm/year, preferably less than 0.55 mm/year, more preferably less than 0.5 mm/year, at a concentration of chlorine dioxide of 1000 ppm at room temperature (20 to 22° C.).

The determination of the corrosion rate of the aqueous solution containing chlorine dioxide is determined according to ASTM Standard G31-72.

According to a particularly preferred embodiment of the present invention, the aqueous solution containing chlorine dioxide is introduced discontinuously into the process water.

Chlorine dioxide can be fed into the process water continuously or discontinuously using an aqueous solution containing chlorine dioxide in order to set the redox potential of the process water to the desired range. When chlorine dioxide is supplied continuously, the redox potential in the process water remains relatively constant as long as the aqueous solution containing chlorine dioxide is metered in. If the supply is discontinuous, on the other hand, chlorine dioxide is fed into the process water at time intervals, whereby, due to the concentration of chlorine dioxide in the process water decreasing over time, the redox potential in the process water is also subject to fluctuations. However, such fluctuations preferably remain within the claimed range.

According to a preferred embodiment of the present invention, the aqueous solution containing chlorine dioxide is metered into the process water if the redox potential of the process water is less than 500 mV, preferably less than 400 mV, more preferably less than 300 mV, more preferably less than 250 mV.

When chlorine dioxide is fed discontinuously into the process water, it is preferably added at a time when the redox potential of the process water falls below a certain value. This value is preferably within the range which is necessary according to the invention in order to control the growth of cells, in particular of microorganisms.

According to a particularly preferred embodiment of the present invention, the aqueous solution containing chlorine dioxide is metered into the process water at least until the redox potential in the process water is 800 mV, preferably 700 mV, more preferably 650 mV.

When chlorine dioxide is fed discontinuously into the process water, it is metered in until the redox potential of the process water reaches a certain value. Upon reaching the predefined threshold value, the metering of chlorine dioxide into the process water is interrupted.

According to a further preferred embodiment of the present invention, in case of discontinuous mixing of the aqueous solution containing chlorine dioxide with the process water, the aqueous solution containing chlorine dioxide is metered into the process water for 30 minutes to 3 hours with an interruption of 30 minutes to 3 hours.

Chlorine dioxide can be metered in for a certain period of time until a predefined value is reached.

According to a preferred embodiment of the present invention, the process water has a temperature of less than 50° C., preferably less than 45° C., when the aqueous solution containing chlorine dioxide is added or present.

The aqueous solution containing chlorine dioxide is fed into the process water preferably at a certain maximum temperature in order to reduce or, respectively, prevent any expulsion of the chlorine dioxide from the aqueous solution or, respectively, the process water. It has been shown that adding it to process water at 50° C. or less leads to essentially no expulsion of chlorine dioxide from the process water. In industrial processes and/or plants in which the process water is subject to temperature fluctuations (e.g., pasteurization plants), it is advantageous to feed the aqueous solution containing chlorine dioxide into the process water at a time when the temperature of the process water remains constant or the process water is in a cooling phase. On the one hand, temperatures below 40° C. can promote the growth of microorganisms, on the other hand, chlorine dioxide is expelled less at temperatures below 50° C.

According to a particularly preferred embodiment of the present invention, the process water has a pH value of 4 to 8, preferably of 4.5 to 7.5, more preferably of 5 to 7, more preferably of 5.5 to 6.5, before and/or after the addition of the aqueous solution containing chlorine dioxide.

It has been shown that the oxidative effect of chlorine dioxide in the process water is particularly high if the process water has a certain pH value in the acidic range. The pH value of the process water is in the range according to the invention either before or at least after the addition of the aqueous solution containing chlorine dioxide.

According to a further preferred embodiment of the present invention, the process water is filtered at one or several points in the industrial plant, preferably with a membrane filter.

Process water is contaminated with particles of various sizes and characteristics and with microorganisms during its use in industrial plants. In order to reduce the number of particles, the process water can be filtered in the process according to the invention. In the course of filtration, microorganisms can also be removed from the process water, depending on the pore size of the filters used. Particularly preferably, membrane filters are used for removing particulate and microbial contaminants from the process water.

The pore size of the membrane filters is preferably less than 10 μm, more preferably less than 5 μm, more preferably less than 2 μm, more preferably less than 1 μm, more preferably less than 0.8 μm, more preferably less than 0.5 μm, more preferably less than 0.2 μm.

The membrane filters can comprise a wide variety of materials, which are selected based on the process water to be filtered, among other things. On the one hand, it should actually be ensured that the membrane material is resistant to the ingredients of the process water to be filtered so that the quality of the membranes of the membrane filter is not impaired, and, on the other hand, particles and microorganisms that are supposed to be removed from the process water should be separable.

The membranes of the filters used according to the invention can comprise ceramic materials and/or polymers. Preferred polymers comprise polysulfones and polyvinyl chloride (PVC).

Depending on how the process water is routed in an industrial plant and depending on the process. the process water can be filtered at one or several points in the industrial plant. In doing so, filtration can take place either before or after the addition of the aqueous solution containing chlorine dioxide to the process water.

According to a preferred embodiment of the present invention, the process water is guided over a collecting basin, and the mixing of the process water with the aqueous solution containing chlorine dioxide occurs preferably in the collecting basin.

The aqueous solution containing chlorine dioxide can be metered into the process water at different points and in different ways. This means that the solution containing chlorine dioxide can be added to the process water in pipes or in other containers of an industrial plant. Particularly preferably, the solution containing chlorine dioxide is added to the process water in a collecting basin preferably equipped with an agitator. As a result, homogeneous mixing of the chlorine dioxide in the process water can be ensured.

According to a preferred embodiment of the present invention, the aqueous solution containing chlorine dioxide is produced by means of a persulfate-chlorite process.

In persulfate-chlorite processes for the production of chlorine dioxide, a chlorite ion is converted into chlorine dioxide by means of the persulfate ion.

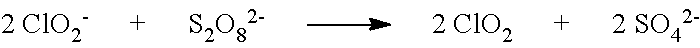

Such processes have the advantage that the concentration of nascent chloride ions is low so that, in the course of the reaction, chlorine dioxide is produced in a molar amount that is usually higher than that of chloride ions.

Processes for the production of aqueous solutions containing chlorine dioxide are well known to those skilled in the art and can be found in relevant reference books. For example, suitable processes are described in U.S. Pat. No. 6,468,479 and in EP 2 654 940.

According to a further preferred embodiment of the present invention, the aqueous solution containing chlorine dioxide is introduced directly into the process water after its production.

It is a major advantage of the present invention that the reaction solution in which chlorine dioxide is produced can be introduced directly into the process water. It is not necessary to remove chlorine dioxide from the reaction mixture, subsequently dissolving it in water again. This makes the entire process not only more economical, but also much safer, since gaseous chlorine dioxide is highly explosive.

The reaction solution of the persulfate-chlorite process can thus be introduced directly into the process water as an aqueous solution containing chlorine dioxide.

According to a particularly preferred embodiment of the present invention, the solution containing chlorine dioxide comprises at least one further oxidizing agent.

In addition to chlorine dioxide, at least one further oxidizing agent can be added to the process water. The advantage of adding a further oxidizing agent is that the amount of chlorine dioxide to be used can be reduced so as to achieve the desired effect. On the other hand, the at least one further oxidizing agent can also be an oxidizing agent used in the production of the solution containing chlorine dioxide.

According to a preferred embodiment of the present invention, the at least one further oxidizing agent is peroxodisulphate.

According to a further preferred embodiment of the present invention, the solution containing chlorine dioxide comprises unreacted peroxodisulphate.

### EXAMPLES

### Example 1: Influence of Chlorine Dioxide on the Microbial Quality of Process Water

In order to examine the influence of chlorine dioxide on the microbial quality of process water, the process water of a first pasteurization plant was mixed with the aqueous solution according to the invention containing chlorine dioxide, and the process water of a second pasteurization plant was mixed with a biocide.

The aqueous solution according to the invention containing chlorine dioxide (prepared with the persulfate-chlorite process) was metered discontinuously into the process water of the first pasteurization plant in an amount so as to keep the redox potential of the process water in the range of 400 to 800 mV. When the redox potential in the process water fell below 400 to 450 mV, the aqueous solution according to the invention containing chlorine dioxide was metered in until a redox potential between 750 and 800 mV was reached.

In contrast, bronopol was added to the process water of the second pasteurization plant on a time-controlled basis (every three days) in such an amount that the concentration of bronopol in the process water was 0.3 to 3 mg/ml.

The microbial contamination in the process water of both pasteurization plants was monitored over a period of 4 months, with the microbial status of the process water being checked twice a week (Monday and Thursday).

The germ count in 1 ml of sample was determined using “Plate Count Agar” (PCA), with the appropriate amount of process water being applied to PCA plates. One plate at a time was incubated at 37° C., and one plate at a time was incubated at 28° C. The evaluation of the germ count took place after 2 and 5 days, respectively.

| | Process water treated with | Process water treated with |
|---|---|---|
| | bronopol | chlorine dioxide |
| | Germ count/ml | Germ count/ml |
| Date | process water | process water |
| 4 Jan. 2021 | 3600 | 280 |
| 7 Jan. 2021 | 4200 | 3840 |
| 11 Jan. 2021 | 3400 | 3480 |
| 14 Jan. 2021 | >10000 | 3120 |
| 18 Jan. 2021 | >10000 | 4160 |
| 21 Jan. 2021 | 60200 | 2100 |
| 25 Jan. 2021 | >10000 | 4800 |
| 28 Jan. 2021 | 54400 | 500 |
| 2 Feb. 2021 | 81600 | 7040 |
| 4 Feb. 2021 | >10000 | 800 |
| 8 Feb. 2021 | >10000 | 80 |
| 11 Feb. 2021 | >10000 | 100 |
| 17 Feb. 2021 | 76000 | 200 |
| 18 Feb. 2021 | >10000 | 1120 |
| 22 Feb. 2021 | >10000 | 1740 |
| 26 Feb. 2021 | 51000 | 2340 |
| 1 Mar. 2021 | >10000 | 940 |
| 12 Mar. 2021 | >10000 | 9200 |
| 15 Mar. 2021 | >10000 | 100 |
| 18 Mar. 2021 | >10000 | 60 |
| 22 Mar. 2021 | >10000 | 8000 |
| 25 Mar. 2021 | >10000 | 10000 |
| 29 Mar. 2021 | >10000 | 10000 |
| 5 Apr. 2021 | >10000 | 160 |
| 8 Apr. 2021 | >10000 | 2800 |
| 12 Apr. 2021 | >10000 | 6560 |
| 15 Apr. 2021 | >10000 | 700 |
| 19 Apr. 2021 | >10000 | 140 |
| 23 Apr. 2021 | >10000 | 2020 |
| 26 Apr. 2021 | >10000 | 4500 |
| 29 Apr. 2021 | >10000 | 3700 |

Concurrently. the redox potential of the pasteurization plant in which chlorine dioxide was metered into the process water was measured at the time of sampling for determining the germ count.

| | Redox potential in |
|---|---|
| Date | process water [mV] |
| 4 Jan. 2021 | 810 |
| 7 Jan. 2021 | 740 |
| 11 Jan. 2021 | 710 |
| 14 Jan. 2021 | 700 |
| 18 Jan. 2021 | 620 |
| 21 Jan. 2021 | 540 |
| 25 Jan. 2021 | 420 |
| 28 Jan. 2021 | 790 |
| 2 Feb. 2021 | 710 |
| 4 Feb. 2021 | 550 |
| 8 Feb. 2021 | 800 |
| 11 Feb. 2021 | 750 |
| 17 Feb. 2021 | 780 |
| 18 Feb. 2021 | 740 |
| 22 Feb. 2021 | 510 |
| 26 Feb. 2021 | 640 |
| 1 Mar. 2021 | 720 |
| 12 Mar. 2021 | 580 |
| 15 Mar. 2021 | 760 |
| 18 Mar. 2021 | 780 |
| 22 Mar. 2021 | 660 |
| 25 Mar. 2021 | 490 |
| 29 Mar. 2021 | 430 |
| 5 Apr. 2021 | 770 |
| 8 Apr. 2021 | 640 |
| 12 Apr. 2021 | 450 |
| 15 Apr. 2021 | 800 |
| 19 Apr. 2021 | 780 |
| 23 Apr. 2021 | 560 |
| 26 Apr. 2021 | 630 |
| 29 Apr. 2021 | 680 |

In 5 measurements within the examination period. the redox potential of the process water treated with bronopol always amounted to more than 1000 mV.

The observed germ counts prove that the use of chlorine dioxide in an amount sufficient to keep the redox potential of the process water in the range of 400 to 800 mV leads to a lower germ count, i.e., the use of conventional biocides such as bronopol.

### Example 2: Corrosion Resistance of Stainless Steel in the Presence of Chlorine Dioxide

In order to check the corrosion resistance of stainless steel in the presence of the aqueous solution according to the invention containing chlorine dioxide, aqueous solutions containing chlorine dioxide, which had been prepared with different processes, were examined. Aqueous solutions containing chlorine dioxide were produced by means of the peroxodisulphate-chlorite process, the hydrochloric acid-chlorite process and the sulfuric acid-chlorite process, using ultrapure water for dissolving the salts or, respectively, for diluting the acids. In addition, an aqueous solution containing chlorine dioxide was produced by introducing chlorine dioxide gas into ultrapure water.

The content of chlorine dioxide in the solutions containing chlorine dioxide, which had been prepared using the above-mentioned processes, was determined by means of DPD (dipropyl-p-phenylenediamine; Palin test). Subsequently, test solutions with a content of chlorine dioxide of 1000 ppm and 50 ppm were prepared from the above-mentioned solutions containing chlorine dioxide and distilled water or, respectively, process water.

Test specimens having dimensions of 9 mm×39 mm and a thickness of 1 mm were manufactured from grade 1.4301 chrome-nickel stainless steel. All test specimens had a bore with a diameter of approx. 5 mm so that they could be dipped into the test solutions using a glass hook.

The test specimens were finally immersed completely in the prepared test solutions comprising chlorine dioxide and were stirred in a three-necked flask with a reflux condenser at 20° C. for 120 h. The content of chlorine dioxide of the test solutions used was checked every 12 to 14 hours and, if necessary, was adjusted to the original initial concentrations of chlorine dioxide (1000 ppm and 50 ppm) by adding more specifically prepared test solution.

The test execution and the calculation were done according to the principles of ASTM G-31-72 (“Standard Practice for Laboratory Immersion Corrosion Testing of Metals”).

The pH values of the aqueous solutions containing chlorine dioxide and the pH values of the test solutions are illustrated in the following table.

| | Aqueous solution | Test solution | Test solution |
|---|---|---|---|
| | containing | 50 ppm | 1000 ppm |
| Source of chlorine | chlorine | ClO₂, | ClO₂, |
| dioxide | dioxide, pH value | pH value | pH value |
| Hydrochloric acid | 2.5 | 3.1 | 2.9 |
| process | | | |
| Sulfuric acid-acid | 1.7 | 2.3 | 2.1 |
| process | | | |
| Persulfate process | 6.2 | 6.4 | 6.3 |
| ClO₂ in distilled | 6.8 | 6.8 | 6.7 |
| water | | | |

### Results

The mass losses of the test specimens after 120 hours are listed in the following table.

| | Test specimen | | | |
|---|---|---|---|---|
| | Weight | Weight | Weight | Weight |
| Source of chlorine dioxide | [g], | [g], | difference | difference |
| Concentration of ClO₂ | 0 h | 120 h | [mg] | (%) |
| Hydrochloric acid process | 15.0313 | 14.9534 | 77.9000 | 0.0052 |
| 50 ppm | | | | |
| Hydrochloric acid process | 15.4513 | 15.3147 | 136.6000 | 0.0088 |
| 1000 ppm | | | | |
| Sulfuric acid 50 ppm | 15.2262 | 15.1237 | 102.5000 | 0.0067 |
| Sulfuric acid 1000 ppm | 15.4105 | 15.2796 | 130.9000 | 0.0085 |
| Persulfate 50 ppm | 15.2765 | 15.2554 | 21.1000 | 0.0014 |
| Persulfate 1000 ppm | 15.3354 | 15.3005 | 34.9000 | 0.0023 |
| ClO₂ in distilled water | 15.3125 | 15.2988 | 13.7000 | 0.0009 |
| 50 ppm | | | | |
| ClO₂ in distilled water | 15.1827 | 15.1507 | 32.0000 | 0.0021 |
| 1000 ppm | | | | |

The loss per year can be calculated from the data determined. The loss of steel per year, expressed as mm/y, is illustrated in the following table.

| | Loss mm/y |
|---|---|
| Manufacturing process, concentration | |
| of ClO₂ 50 ppm | |
| Hydrochloric acid process | 0.378860759 |
| Sulfuric acid process | 0.498500999 |
| Persulfate process | 0.102618254 |
| ClO₂ in distilled water | 0.066628914 |
| Manufacturing process, concentration | |
| of ClO₂ 1000 ppm | |
| Hydrochloric acid process | 0.664343771 |
| Sulfuric acid process | 0.636622252 |
| Persulfate process | 0.169733511 |
| ClO₂ in distilled water | 0.15562958 |

The results show that the use of aqueous solutions containing chlorine dioxide, which were prepared using the hydrochloric acid process, leads to increased corrosion of stainless steel. This observation is due to the increased concentration of chloride ions in the aqueous solution and the low pH value of the solution which are generated in the corresponding manufacturing process. In order to reduce the concentration of chloride ions and thus the corrosiveness of such solutions containing chlorine dioxide, an alternative process was used for the production of chlorine dioxide ions. In the sulfuric acid process, a much smaller amount of chloride ions accumulates in comparison to the hydrochloric acid process. Nevertheless, aqueous solutions containing chlorine dioxide that had been produced using a sulfuric acid process also showed increased corrosiveness. This is due to the low pH value of the corresponding aqueous solution containing chlorine dioxide. Surprisingly, the best results in terms of corrosiveness could be achieved with an aqueous solution containing chlorine dioxide that had been produced using the persulfate process. These results are surprising because, at a concentration of 1000 ppm, the corrosiveness is comparable to a test solution in which chlorine dioxide gas has been directly dissolved.

In addition, it has surprisingly been found that distilled water mixed with the solution according to the invention containing chlorine dioxide has essentially the same corrosive properties as process water comprising 80 ppm chloride ions which was mixed with the same amount of solution containing chlorine dioxide. This result is surprising especially because, due to the presence of chloride ions in the process water, the absolute amount of chloride ions was higher than in the distilled water. This shows that what matters is the molar ratio of chlorine dioxide to chloride ions in the aqueous solution according to the invention containing chlorine dioxide and the pH value thereof. Especially the pH value of the process water can easily be influenced by the solution containing chlorine dioxide.

### Example 3: Impact of the Molar Ratio Between Chlorine Dioxide and Chloride Ions in the Aqueous Solution Containing Chlorine Dioxide on the Corrosiveness Thereof

The corrosiveness of the aqueous solution according to the invention containing chlorine dioxide depends on the molar ratio of chlorine dioxide to chloride ions in the solution. In order to show this, the aqueous solution according to the invention containing chlorine dioxide (prepared as described in Example 1), whose molar ratio of chlorine dioxide to chloride ions is more than 1, was mixed with sodium chloride in order to increase the amount of chloride ions in the solution. Subsequently, the corrosion resistance tests were conducted with 1000 ppm chlorine dioxide in the test solution, as described in Example 2. In doing so, the following results were obtained:

| Test | Molar ratio chlorine | |
|---|---|---|
| solution | dioxide:chloride ions | Loss mm/y |
| 1 | >1 | 0.1587955 |
| 2 | approx. 1:2 | 0.6125843 |
| 3 | approx. 1:5 | 0.6872435 |
| 4 | approx. 1:10 | 0.8532145 |

It has surprisingly been shown that, with a molar excess of chloride ions compared to dissolved chlorine dioxide, the corrosion rates are significantly increased in comparison to stainless steel.

1. A process for controlling the growth of microorganisms in at least partially circulating process water of an industrial plant, comprising the step of introducing an aqueous solution containing chlorine dioxide into the process water in order to set a redox potential of 400 to 800 mV in the process water, wherein the aqueous solution containing chlorine dioxide having a pH value of 4 to 7.5 and a ratio of chlorine dioxide to chloride ions of greater than 1, wherein the process water having a temperature of 5 to 50° C.

2. The process according to claim 1, wherein, as a result of the introduction of the aqueous solution containing chlorine dioxide, the redox potential of the process water is set to 400 to 700 mV.

3. The process according to claim 1, wherein, after the introduction of the aqueous solution containing chlorine dioxide, the concentration of chlorine dioxide in the process water ranges from 0.02 to 0.9 ppm.

4. The process according to claim 1, wherein the concentration of chlorine dioxide in the aqueous solution containing chlorine dioxide ranges from 1,000 to 40,000 ppm.

5. The process according to claim 1, wherein the aqueous solution containing chlorine dioxide is introduced discontinuously into the process water.

6. The process according to claim 5, wherein the aqueous solution containing chlorine dioxide is introduced into the process water when the redox potential of the process water is less than 500 m V.

7. The process according to claim 5, wherein the aqueous solution containing chlorine dioxide is introduced into the process water at least until the redox potential in the process water is 800 m V.

8. The process according to claim 5, wherein when the aqueous solution containing chlorine dioxide is introduced discontinuously into the process water, the aqueous solution containing chlorine dioxide is introduced into the process water for 30 minutes to 5 hours, with an interruption of 30 minutes to 5 hours.

9. The process according to claim 1, wherein an the aqueous solution containing chlorine dioxide is introduced into the process water for 30 minutes to 5 hours, to set the redox potential in the process water to between 600 and 800 m V.

10. The process according to claim 1, wherein, before and/or after the introduction of the aqueous solution containing chlorine dioxide into the process water, the process water has a temperature of less than 50° C.

11. The process according to claim 1, wherein the process water is filtered at one or several points in the industrial plant, preferably with a membrane filter.

12. The process according to claim 1, wherein the process water is guided over a collecting basin and the introduction of the aqueous solution containing chlorine dioxide into the process water occurs in the collecting basin.

13. The process according to claim 1, wherein the aqueous solution containing chlorine dioxide is produced by means of a persulfate-chlorite process.

14. The process according to claim 1, wherein the aqueous solution containing chlorine dioxide is introduced directly into the process water after its production.

15. The process according to claim 2, wherein the redox potential of the process water is set to 400 to 650 mV, or to 400 to 600 mV.

16. The process according claim 3, wherein the concentration of chlorine dioxide in the process water ranges from 0.05 to 0.8 ppm, or from 0.05 to 0.5 ppm, or from 0.1 to 0.5 ppm.

17. The process according to claim 4, wherein the concentration of chlorine dioxide in the aqueous solution containing chlorine dioxide ranges from 2,000 to 30,000 ppm, or from 5,000 to 20,000 ppm.

18. The process according to claim 6, wherein the aqueous solution containing chlorine dioxide is introduced into the process water when the redox potential of the process water is less than 450 mV, or less than 420 mV.

19. The process according to claim 7, wherein the aqueous solution containing chlorine dioxide is introduced into the process water at least until the redox potential in the process water is 700 mV, or 650 mV.

20. The process according to claim 8, wherein the aqueous solution containing chlorine dioxide is introduced into the process water for I to 3 hours, with an interruption of 30 minutes to 5 hours, or for 3 to 5 hours.
